(19) United States
(12) Patent Application Publication
(10) Pub. No.: US 2025/0155193 A1
(43) Pub. Date: May 15, 2025

(54) MATERIAL DRYING APPARATUS

(71) Applicant: B&T Technologies LLC, Coral Springs, FL (US)

(72) Inventor: William H. Moss, Coral Springs, FL (US)

(21) Appl. No.: 18/939,991

(22) Filed: Nov. 7, 2024

Related U.S. Application Data
(60) Provisional application No. 63/558,486, filed on Feb. 27, 2024.
(60) Provisional application No. 63/558,478, filed on Feb. 27, 2024.
(60) Provisional application No. 63/562,121, filed on Mar. 6, 2024.
(60) Provisional application No. 63/562,113, filed on Mar. 6, 2024.
(60) Provisional application No. 63/564,837, filed on Mar. 13, 2024.
(60) Provisional application No. 63/564,875, filed on Mar. 13, 2024.
(60) Provisional application No. 63/598,249, filed on Nov. 13, 2023.

(51) Int. Cl. F26B 3/08; F26B 25/12

(52) U.S. Cl. CPC F26B 3/082; F26B 25/12

(57) ABSTRACT

A material drying apparatus is disclosed, including a fluidizing bed plate attached to an interior surface of a fluid bed dryer. A side entry for fluidizing air delivery is provided to the fluid bed dryer to enable multiple fluid bed dryer modules to be connected in series, making possible drying of materials which require a high length-to-width ratio and for extended drying time. A fan directs heated fluidizing air through a perforated bottom of the fluidizing bed plate. Turning vanes are positioned within the fluid bed dryer to reduce turbulence of the heated fluidizing air. An expanded upper plenum reduces upflow velocity within the fluid bed dryer. An access door enables efficient cleaning and maintenance access to an interior of the fluid bed dryer.

### CROSS-REFERENCE TO RELATED APPLICATIONS

The present application claims priority to U.S. Provisional Patent Application No. 63/598,249 filed Nov. 13, 2023, titled “NON-PLUGGING FLUIDIZING BED PLATE”; U.S. Provisional Application No. 63/558,486 filed Feb. 27, 2024, titled “SIDE ENTRY FOR FLUIDIZING AIR DELIVERY TO A FLUID BED DRYER”; U.S. Provisional Application No. 63/558,478 filed Feb. 27,2024, titled “MULTI-UNIT DRYER FOR MATERIAL REQUIRING LOW TEMPERATURE DRYING”; U.S. Provisional Application No. 63/562,121 filed Mar. 6, 2024, titled “REMOVABLE FLUIDIZING BED PLATE,”; U.S. Provisional Patent Application No. 63/562,113 filed Mar. 6, 2024, titled “EXPANDED UPPER PLENUM TO REDUCE UPFLOW VELOCITY IN A FLUID BED DRYER”; U.S. Provisional Application No. 63/564,837 filed Mar. 13, 2024, titled “ACCESS DOOR TO ENABLE CLEANING OF A FLUIDIZING BED DRYER”; U.S. Provisional Application No. 63/564,875 filed Mar. 13, 2024, titled “FLUIDIZING BED DRYER INCLUDING TURNING VANES TO REDUCE TURBULENCE”, which is hereby incorporated by reference in its entirety.

### TECHNICAL FIELD

The present invention relates generally to a material drying apparatuses.

### BACKGROUND

This invention finds specific application in the field of treating agricultural grain products such as soybeans, corn and cereal grains in processes to condition those grains for more efficient usage as feed products for agricultural purposes such as the feeding of livestock such as dairy cattle as well as other types of livestock. Food products such as soybeans require significant treatment to place them in a condition where they may be usable as a food product for livestock. Other grains are similarly treated to enhance their effectiveness in development of the nutrients required by the livestock such as dairy cattle in production of milk and in hogs for meat production. The treatment processes also enhance the efficacy of the grain and cereal products in the digestive system of livestock.

One particular treating process that has been found uniquely effective in processing of grain such as soybeans as well as corn and other cereal grain is subjecting them to elevated temperatures of predetermined magnitude and particular length of time whereby the nutrients of the grains will be processed to a state where they are more efficient in the providing of the nutrients to the livestock during the course of the digestive process. Additionally, in connection with soybeans, such heat treatment also has the advantage of converting the soybeans to a state where they are more readily digested by livestock and thus substantially enhances their utilization.

Apparatus for effecting heat treatment of agricultural grain feed products have been devised and heretofore utilized, but they have not been found to be as efficient and effective in their operation as is desired. An example of a fluidized bed-type apparatus for treating of such particulate material as grain products is disclosed in U.S. Pat. No. 4,419,834 issued to John F. Scott on Dec. 13, 1983. This patent discloses an apparatus having a closed chamber provided with a perforated bedplate across which the grain products are caused to traverse while concurrently effecting a flow of heated air through the perforated plate to effect heating of the grain products. The heated air not only effects the treatment of the particulate material, but it is also utilized in effecting levitation of the particles thereby resulting in a fluidized bed of material. The fluidized bed facilitates the treatment through producing larger voids or spaces as between the particles whereby the air may more freely flow and will also be able to more thoroughly and completely flow around the individual particles and thus better assure that the process and treatment of the material is more effectively and fully completed.

U.S. Pat. No. 4,419,834 had cylindrical, straight, thru-hole apertures or holes which are typical of known fluidized bed dryers. Cylindrical holes have been found to provide inadequate functioning of the fluidized bed, both as to the levitation as well as effecting of the treatment of the particulate material. One structural disadvantage of the cylindrical holes is that the conveyor devices utilized to cause traversing movement of the particulate material tend to force particles or portions of the particles into the apertures (plugging).

Single fluidized bed dryers are known to include one fan for fluidizing air, one means of adding thermal energy (for example, a single gas burner), and one fluidizing dryer chamber. Specifically, U.S. Pat. No. 5,238,399 discloses such a dryer which has a single fluid bed dryer. This type of dryer provides a high-heat environment to draw the material and cannot be utilized for materials which are heat-sensitive and require longer drying times at lower temperatures.

U.S. Pat. No. 5,238,399 describes a single fluid bed dryer with one fan for fluidizing air., one means of adding thermal energy (e.g., a gas burner), and one fluidizing dryer chamber. In the '399 Patent, the upper plenum was formed a square which did not adequately reduce upflow velocity, causing an excess of fines to be transmitted to the cyclone. The excess fines resulted in the cyclone needing to be cleaned regularly to prevent fires from starting during the drying process.

During the material drying process, material can become stuck to the surfaces within the dryer which must be regularly cleaned. This involves a laborer accessing the interior of the dryer which can be strenuous and time consuming. Further, in the '399 Patent, the dryer must be at least partially disassembled, and the explosion hatch must be removed. The dryer disclosed in the '399 patent also fails to include means for reducing turbulence which causes a reduction in powder formation which is undesirable. Further, the '399 patent discloses such a dryer which has a single fluid bed dryer having a front-facing entry for the fluidizing air which does not allow for the input of materials requiring a high length-to-width ratio (e.g., 30:1) for long drying time. The existing systems which use a single chamber dryer do not permit multiple temperature zones, causing the drying process to be repeated multiple times at lower temperatures. This increases drying time and requires additional handling by an operator to run multiple drying cycles.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein are an improvement to a material drying apparatus, including a fluidizing bed plate attached to an interior surface of a fluid bed dryer. A side entry for fluidizing air delivery is provided to the fluid bed dryer to enable multiple fluid bed dryer modules to be connected in series, making possible drying of materials which require a high length-to-width ratio and for extended drying time. A fan directs heated fluidizing air through a perforated bottom of the fluidizing bed plate. Turning vanes are positioned within the fluid bed dryer to reduce turbulence of the heated fluidizing air. An expanded upper plenum reduces upflow velocity within the fluid bed dryer. An access door enables efficient cleaning and maintenance access to an interior of the fluid bed dryer.

In some aspects, the fluidizing bed plate includes a plurality of fluid transmitting apertures, wherein each of the plurality of fluid transmitting apertures includes a bottom half and a top half, wherein a frustoconical form is machined into the bottom half of each of the plurality of fluid transmitting apertures, and wherein a cylindrical form is machined into the top half of each of the plurality of fluid transmitting apertures.

In some aspects, the fluidizing bed plate is constructed as a non-plugging fluidizing bed plate to reduce turbulence and plugging of the fluidizing bed plate to reduce the formation of powder.

In some aspects, the fluidizing bed plate is removably secured to the interior surface of the fluid bed dryer via a one or more fasteners to allow removal of the fluid bed plate for cleaning plugged apertures.

In some aspects, a bypass door is positioned exterior of a discharge airlock to enable access to the access door without releasing a discharge airlock.

In some aspects, the one or more turning vanes reduce air turbulence, thereby reducing the formation of a powder during the material drying process.

In some aspects, the expanded upper plenum allows particles entrained in exhaust gas to fall back onto the fluidizing bed and exit the fluidizing bed dryer.

In some aspects, the fluid bed dryer is constructed as a multi-unit fluid bed dryer to enable drying of materials which require low temperature drying.

The material drying apparatus may be constructed as a multi-unit material drying apparatus which includes a plurality of fluid bed dryers connected in series, each fluid bed dryer includes a fluidizing bed plate attached to an interior surface of a fluid bed dryer, a side entry for fluidizing air delivery to the fluid bed dryer to enable the drying of materials which require a high length-to-width ratio and an extended drying time, and a fan to direct heated fluidizing air through a perforated bottom of the fluidizing bed plate. Further, each fluid bed dryer includes one or more turning vanes positioned within the fluid bed dryer to reduce turbulence of the heated fluidizing air and an expanded upper plenum to reduce upflow velocity within the fluid bed dryer. An access door enables efficient cleaning and maintenance access to an interior of the fluid bed dryer. The plurality of fluid bed dryers connected in series form the multi-unit material drying apparatus to enable drying of materials requiring low temperature drying with longer solids residence time.

These and other objects, features, and advantages of the present invention will become more readily apparent from the attached drawings and the detailed description of the preferred embodiments, which follow.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of a material drying apparatus, according to some embodiments;

FIG. 2 illustrates a perspective view of a multi-unit material drying apparatus, according to some embodiments;

FIG. 3 illustrates a top plan view of the perforated bottom of the fluidizing bed plate, according to some embodiments;

FIG. 4A illustrates a side elevation view of the apertures of the perforated bottom of the fluidizing bed plate, according to some embodiments;

FIG. 4B illustrates a cross-section view of the apertures of the perforated bottom of the fluidizing bed plate, according to some embodiments;

FIG. 5 illustrates a perspective view of the material drying apparatus including the turning vanes, according to some embodiments;

FIG. 6 illustrates a perspective view of the material drying apparatus including the air inlets, according to some embodiments; and

FIG. 7 illustrates a schematic of the material drying apparatus including the access door, expanded upper plenum, turning vanes, and side entry.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a material drying apparatus having various features to improve the process of drying materials and maintenance of the apparatus. The material drying apparatus may be configured as a single unit or as a multi-unit material drying apparatus. The multi-unit drying apparatus enables the drying of materials requiring low temperature drying and a longer solids residence time.

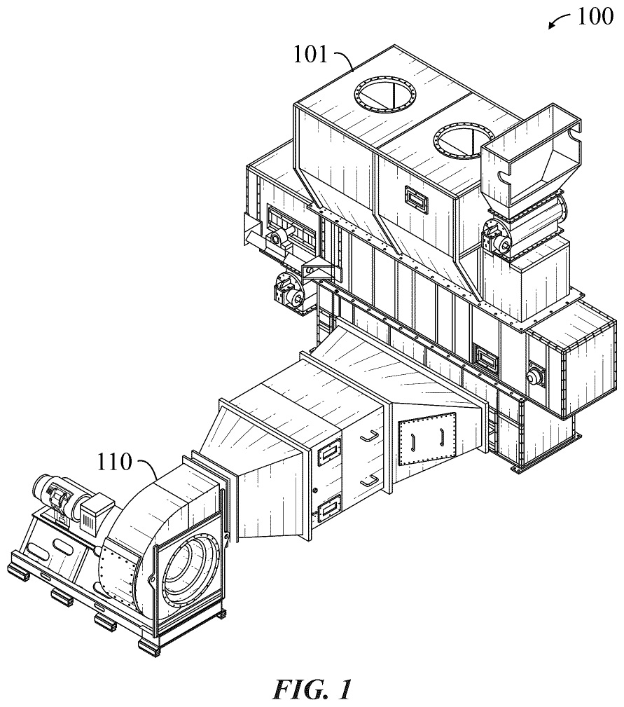

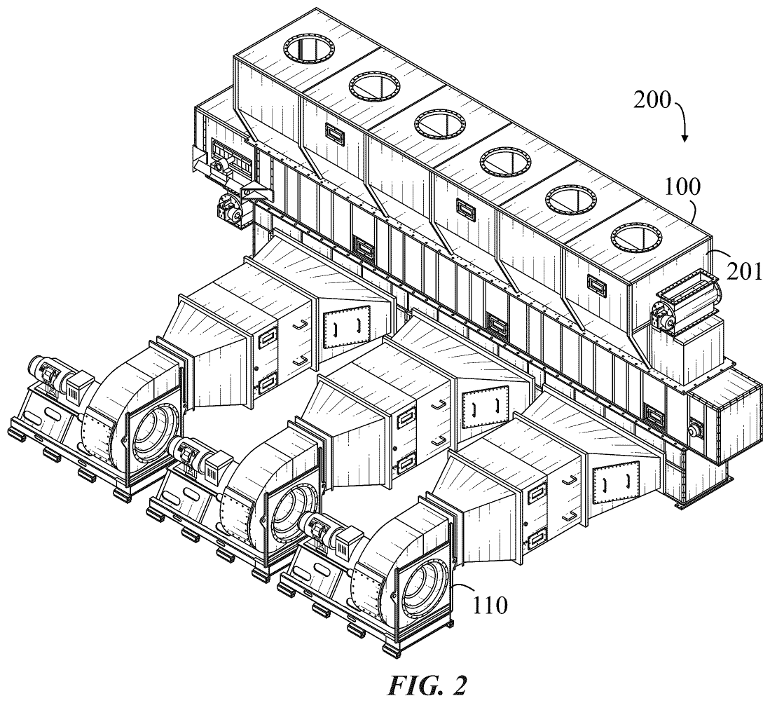

FIG. 1 illustrates the material unit drying apparatus 100 in a single-unit configuration 101. FIG. 2 illustrates a multi-unit material drying apparatus 200 which includes a plurality of material drying apparatus 100 as illustrated in FIG. 1, connected in series to enable low temperature drying and longer solids residence time. Each material drying apparatus 100 includes a fan 110 to direct the flow of heated fluidizing air through a perforated bottom of the fluidizing bed plate within the interior of the material drying apparatus 100.

In some embodiments, the multi-unit fluidizing bed dryer 200 includes two or more fluid bed drying chambers 201 positioned in series with one another. Fans 110 direct heated fluidizing air under a perforated bed plate to levitate a plurality of uniform objects to create high velocity air flow across the plurality of uniform objects to dry the plurality of objects via convection. The two or more fluid bed drying chambers are connected in series with a single drag chain conveyor moving material through the fluid bed drying chambers to provide a long residence time and enable drying of the plurality of objects at a lower temperature to prevent the caramelization of sugars.

The multi-unit fluidizing bed dryer 200 provides the ability to dry materials which are unsuitable for drying at high temperatures. This can include organic materials, and especially those having a high sugar content, which can be damaged or degraded at typical fluid bed drying temperatures. Longer residence times and lower temperatures are beneficial for preventing the caramelization of sugars in citrus peels and other high sugar organic material.

During use, heated warm fluidizing air (having a temperature of about 300-350 degrees Fahrenheit) is directed under a perforated bed plate. The fluidizing warm air levitates the uniform objects creating high velocity gentle warm air flow across the objects to dry via convection (not radiation or conduction heating/drying). The perforated bed plate provides for uniform air distribution. The new design allows multiple dryers to be connected in series with a single drag chain conveyor moving material through the dryer slowly for a longer residence time. Fluidizing air can be a lower temperature to prevent caramelizing sugars.

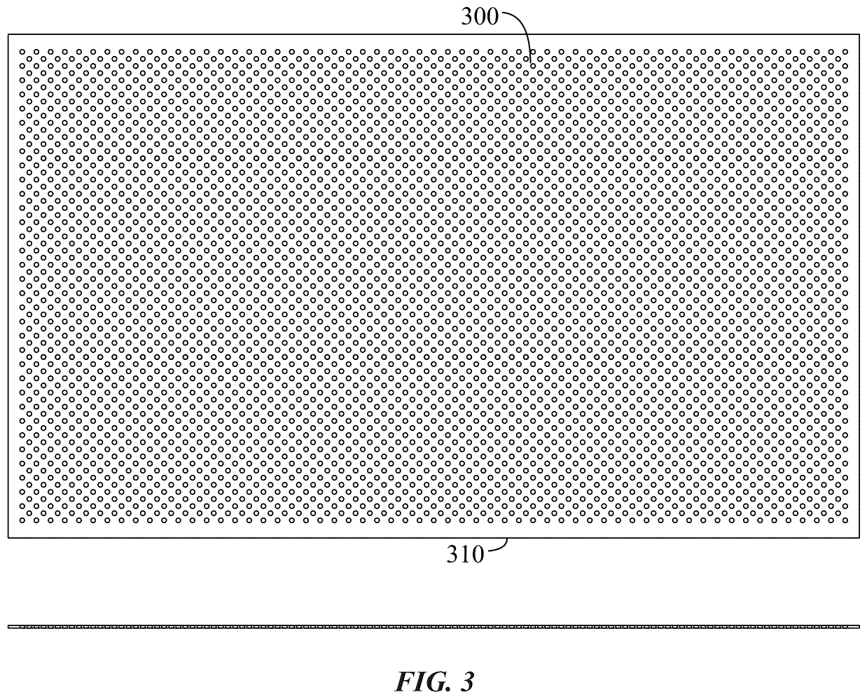

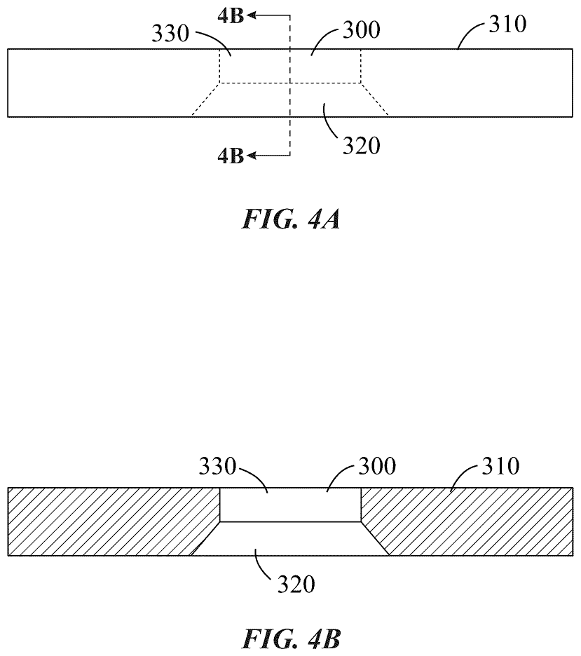

FIG. 3, FIG. 4A and FIG. 4B illustrate an improvement to a frusto-conically shaped apertures 300 on a non-plugging fluidizing bed plate 310. The improved design reduces the frequency and severity of plugging and reduces turbulence, thereby improving levitation in the fluidizing process and reducing formation of powder from violent collisions of drying pellet shapes in the fluid bed dryer. Each frusto-conically shaped apertures 300 (cones) are machined through the bottom half 320 of the aperture 300 while the top half 330 is configured as a straight cylinder.

In addition to the enhanced performance in treatment of the particulate material with the apparatus of this invention using the bedplate formed with the frusto-conical apertures 300, there are other significant advantages obtained with this invention over the prior art bedplates having cylindrical apertures. One further advantage is that the airflow patterns produced by this bedplate 310 result in a substantial reduction in the power requirements for effecting the airflow and consequent reduction in operating costs. A second further advantage is that the airflow patterns developed by the frusto-conical apertures 300 substantially reduce the noise that is generated as compared to bedplates having the cylindrical walled apertures of the prior art.

During use, heated warm fluidizing air (300-350 deg F) is directed under a perforated bed plate. The fluidizing warm air levitates the uniform objects (which in the embodiments provided are long uniform spaghetti-like strands which become pellets—2:1 aspect ratio length-to-diameter as the collide and dry), creating high velocity gentle warm air flow across the objects to dry via convection (not radiation or conduction heating/drying). The perforated bed plate provides for uniform air distribution. The perforations (frusto-conically shaped apertures 300 (cones) are machined through the bottom half of the aperture; top half is straight cylinder) provides less violent pellet collisions resulting in less powder formation and less plugging of the perforations 330 (apertures 300) from powder than previous designs.

The non-plugging fluidizing bed plate 310 may be removable, rather than being welded in place within the dryer. Periodic cleaning is required to unclog plugged holes in the bed plate and remove sticky, caramelized sugars and burnt/caked material that was too wet or would not fluidize/levitate when applied to the fluid bed dryer. The system improves on the prior art by facilitating fast and efficient cleaning, reduced labor to clean. The removable non-plugging fluidizing bed plate 310 includes a plurality of slots to hold the removable non-plugging fluidizing bed plate 310 in place. This allows the fluidized bed plate 310 to slide out from the dryer to allow cleaning or sandblasting to remove sticky, caked on substances or plugged perforations on tabletops or supports. This is preferable to previous systems and is less time consuming than cleaning inside confined spaces of the fluid bed dryer because the bed plate has been welded in place.

The material drying apparatus may include a drag chain frame, drag chain perforated deck top securing component, drag chain perforated deck bottom securing component, and the removable non-plugging fluidizing bed plate 310.

In some embodiments, the bed plate holder may be manufactured from steel channels, or round steel rods, square steel rods, or similar materials.

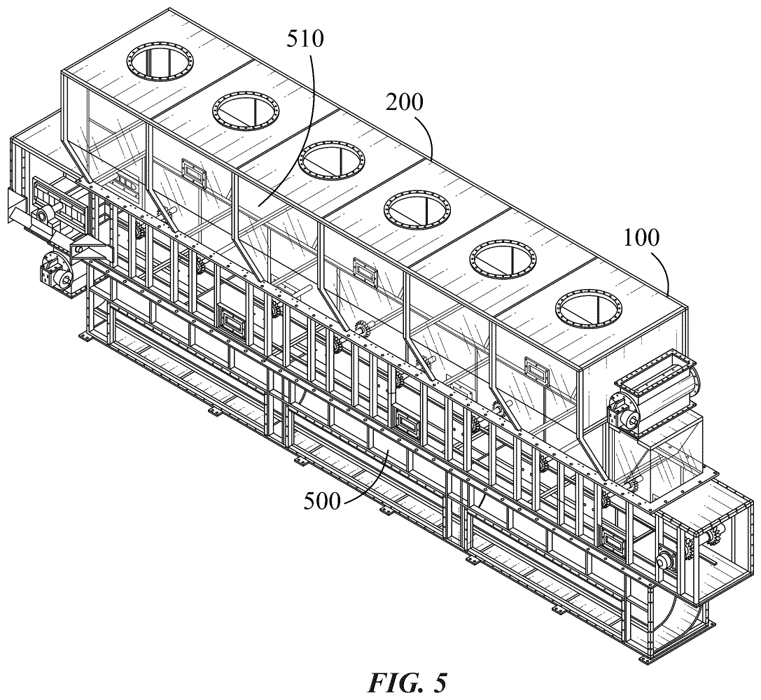

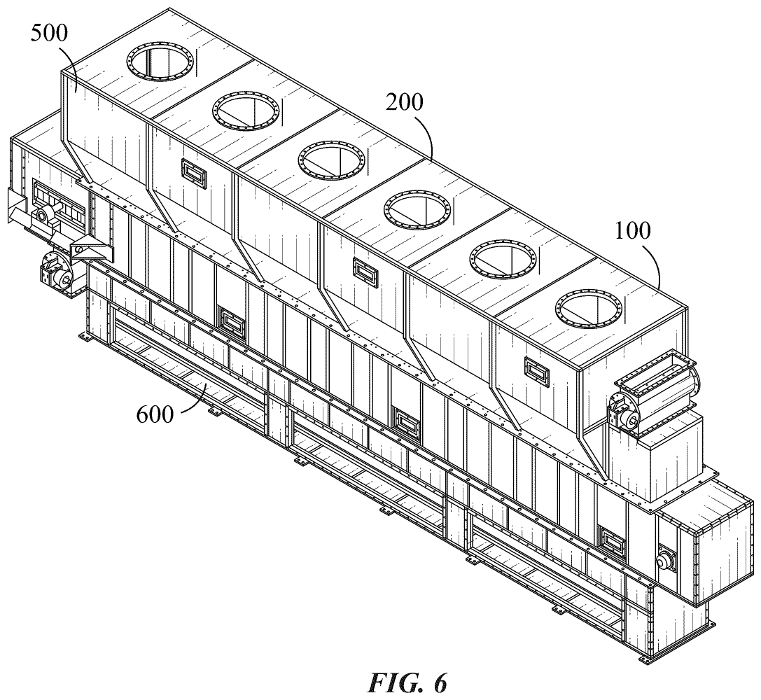

FIG. 5 and FIG. 6 each illustrate the multi-unit material drying apparatus 200, wherein FIG. 5 depicts each single unit material drying apparatus 100 having the front panel removed to show the turning vanes 500. The turning vanes 500 direct the fluidizing gas to equally distribute across the perforated fluid bed plate provided within each drying chamber 510. The turning vanes 500 significantly reduce turbulence, causing a significant reduction in powder formation. FIG. 6 illustrates the air inlets 600 which enable the fain-driven flow of air into each drying chamber 510.

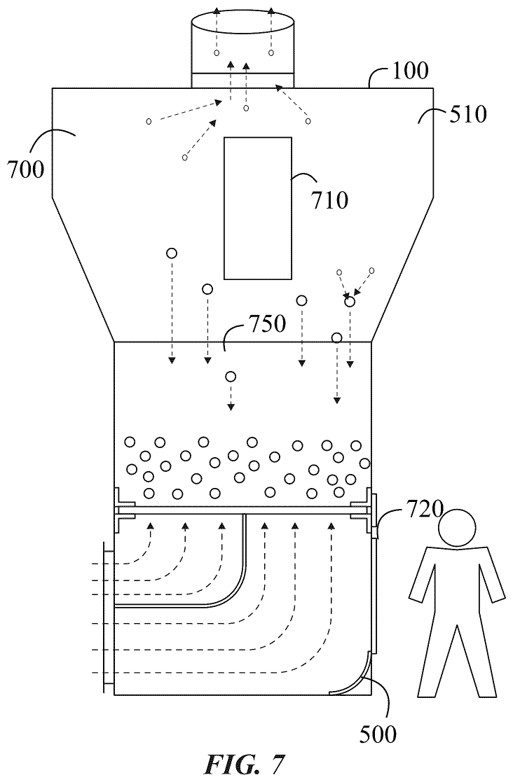

FIG. 7 illustrates a schematic of the material drying apparatus 100 (shown as a single unit for clarity). Each material drying apparatus 100 includes a drying chamber 510 having an expanded upper plenum 700, turning vanes 500, access door 710, and side entry 720. The expanded upper plenum 700 provides a material drying system which allows for the heavier fines to remain with the dried product. This reduces the amount of fines which are transferred to the cyclone, lengthening the time interval when cleaning is necessary by preventing the buildup of ignitable material in the dust collector/cyclone. As a result, the expanded upper plenum 700 reduces the risk of a fire starting due to the buildup of combustible materials in the cyclone. Further, the expanded upper plenum 700 of the material drying apparatus 100 reduces the upflow velocity of the fluidizing gas after drying, allowing particles entrained in the exhaust gas of the dryer to fall back onto the levitating fluid bed and exit with the solid dry material.

The access door 710 allows the ingress and egress into the drying chamber 510 during maintenance and cleaning processes. This eliminates the need to remove the explosion hatch and provides the laborer with a more comfortable way of accessing the interior of the dryer. Further, the access door 710 removes the need for the laborer to wear a ventilation device. The access door 710 improves the efficiency of the cleaning and maintenance processes by providing easier access to the interior of the dryer.

During the material drying process, it is common for materials to become stuck to the interior surfaces of the fluidizing bed dryer 750. This requires regular cleaning of the interior of the fluidizing bed dryer which is performed by a laborer wearing a ventilator who must gain access into the interior of the dryer. Gaining access to the interior of the dryer involves its partial disassembly and requires the laborer to work in confined and uncomfortable spaces.

The side entry 720 enables the delivery of fluidizing air to the drying chamber 510 of the fluid bed dryer 750. This is beneficial for the drying of materials which require a high length-to-weight ratio and an extended drying time. The side entry 720 of fluidizing air allows for multiple dryers with side entry fans and burners. This configuration also makes possible multi-temperature zones (higher temperature in zone 1 when product to be dried is more wet and lower temperatures in zone 2 and zone 3 when product is drier). It is common that the materials will require a slower drying rate when moisture in the raw material is lower. Fluidizing air can be a lower temperature to prevent the caramelization of sugars in products having a high sugar content. This allows for longer drying times at lower temperatures to be utilized. The side entry dryers make possible equal distribution of fluidizing air and varying fluidizing air temperatures along the length of a long length-to-width dryer (5:1 to 30:1).

In some embodiments, multiple drying chambers 510 with multiple side entry 720 systems directing air using fans can be used. This system uses a single drag chain to push material through the dryer. Multiple side entry fluidizing fans may utilize one burner for each fan to allow for different temperatures in each chamber.

The embodiments allow for the drying of organic material which would be damaged at typical fluid bed drying temperatures.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A material drying apparatus, comprising:
a fluidizing bed plate attached to an interior surface of a fluid bed dryer;
a side entry for fluidizing air delivery to the fluid bed dryer to enable multiple fluid bed dryer modules to be connected in series, making possible drying of materials which require a high length-to-width ratio and for extended drying time;
a fan to direct heated fluidizing air through a perforated bottom of the fluidizing bed plate;
one or more turning vanes positioned within the fluid bed dryer to reduce turbulence of the heated fluidizing air;
expanded upper plenum to reduce upflow velocity within the fluid bed dryer; and
an access door to enable efficient cleaning and maintenance access to an interior of the fluid bed dryer.

2. The material drying apparatus of claim 1, wherein the fluidizing bed plate includes a plurality of fluid transmitting apertures, wherein each of the plurality of fluid transmitting apertures includes a bottom half and a top half, wherein a frustoconical form is machined into the bottom half of each of the plurality of fluid transmitting apertures, and wherein a cylindrical form is machined into the top half of each of the plurality of fluid transmitting apertures.

3. The material drying apparatus of claim 1, wherein the fluidizing bed plate is constructed as a non-plugging fluidizing bed plate to reduce turbulence and plugging of the fluidizing bed plate to reduce the formation of powder.

4. The material drying apparatus of claim 1, wherein the fluidizing bed plate is removably secured to the interior surface of the fluid bed dryer via a one or more fasteners to allow removal of the fluid bed plate for cleaning plugged apertures.

5. The material drying apparatus of claim 1, further comprising a bypass door positioned exterior of THE discharge airlock, the bypass door to enable access to the access door without releasing a discharge airlock.

6. The material drying apparatus of claim 1, wherein the one or more turning vanes reduce air turbulence, thereby reducing the formation of a powder during the material drying process.

7. The material drying apparatus of claim 1, wherein the expanded upper plenum allows particles entrained in exhaust gas to fall back onto the fluidizing bed and exit the fluidizing bed dryer.

8. The material drying apparatus of claim 1, wherein the fluid bed dryer is constructed as a multi-unit fluid bed dryer to enable drying of materials which require low temperature drying.

9. A multi-unit material drying apparatus, comprising:
a plurality of fluid bed dryers connected in series, each fluid bed dryer comprising:
a fluidizing bed plate attached to an interior surface of a fluid bed dryer;
a side entry for fluidizing air delivery to the fluid bed dryer to enable the drying of materials which require a high length-to-width ratio and an extended drying time;
a fan to direct heated fluidizing air through a perforated bottom of the fluidizing bed plate;
one or more turning vanes positioned within the fluid bed dryer to reduce turbulence of the heated fluidizing air;
expanded upper plenum to reduce upflow velocity within the fluid bed dryer; and
an access door to enable efficient cleaning and maintenance access to an interior of the fluid bed dryer,
wherein the plurality of fluid bed dryers form a multi-unit material drying apparatus to enable drying of materials requiring low temperature drying with longer solids residence time.

10. The material drying apparatus of claim 9, wherein the fluidizing bed plate includes a plurality of fluid transmitting apertures, wherein each of the plurality of fluid transmitting apertures includes a bottom half and a top half, wherein a frustoconical form is machined into the bottom half of each of the plurality of fluid transmitting apertures, and wherein a cylindrical form is machined into the top half of each of the plurality of fluid transmitting apertures.

11. The material drying apparatus of claim 9, wherein the fluidizing bed plate is constructed as a non-plugging fluidizing bed plate to reduce turbulence and plugging of the fluidizing bed plate to reduce the formation of powder.

12. The material drying apparatus of claim 9, wherein the fluidizing bed plate is removably secured to the interior surface of the fluid bed dryer via a one or more fasteners to allow removal of the fluid bed plate for cleaning plugged apertures.

13. The material drying apparatus of claim 9, further comprising a bypass door positioned exterior of a discharge airlock, the bypass door to enable access to the access door without releasing a discharge airlock.

14. The material drying apparatus of claim 9, wherein the one or more turning vanes reduce air turbulence, thereby reducing the formation of a powder during the material drying process.

15. The material drying apparatus of claim 9, wherein the expanded upper plenum allows particles entrained in exhaust gas to fall back onto the fluidizing bed and exit the fluidizing bed dryer.

16. The material drying apparatus of claim 1, wherein the fluid bed dryer is constructed as a multi-unit fluid bed dryer to enable drying of materials which require low temperature drying with longer solids residence.

17. A material drying apparatus, comprising:
one or more fluid bed dryers, each comprising:
an air inlet to allow the ingress of fluidizing air driven by a fan, the fan to direct the flow of the fluidizing air to a burner to heat the fluidizing air, and the fan to direct the flow of air through a perforated fluidizing bed plate attached to an interior surface of a fluid bed dryer, the perforated fluidizing bed plate position in an interior of the one or more fluid bed dryers;
a side entry for fluidizing air delivery to the fluid bed dryer to enable the drying of materials which require a high length-to-width ratio and an extended drying time;
one or more turning vanes positioned within the fluid bed dryer to reduce turbulence of the heated fluidizing air;
an expanded upper plenum to increase the volume of the interior of the one or more fluid bed dryers, and to reduce upflow velocity within the fluid bed dryer; and
an access door to enable efficient cleaning and maintenance access to an interior of the fluid bed dryer.

18. The material drying apparatus of claim 17, wherein the fluidizing bed plate includes a plurality of fluid transmitting apertures, wherein each of the plurality of fluid transmitting apertures includes a bottom half and a top half, wherein a frustoconical form is machined into the bottom half of each of the plurality of fluid transmitting apertures, and wherein a cylindrical form is machined into the top half of each of the plurality of fluid transmitting apertures.

19. The material drying apparatus of claim 17, wherein the fluidizing bed plate is constructed as a non-plugging fluidizing bed plate to reduce turbulence and plugging of the fluidizing bed plate to reduce the formation of powder, and wherein the fluidizing bed plate is removably secured to the interior surface of the fluid bed dryer via a one or more fasteners to allow removal of the fluid bed plate for cleaning plugged apertures.

20. The material drying apparatus of claim 17, wherein the material drying apparatus is capable of drying a raw material formed into a uniform pellet shape, wherein the raw material requires an extended drying process at a low temperature.
